(19) United States
(12) Patent Application Publication
(10) Pub. No.: US 2003/0115258 A1
(43) Pub. Date: Jun. 19, 2003

(54) Time zone difference based locality estimation between web clients and E-business servers

(75) Inventors: Sascha Baumeister, Stuttgart (DE); Sarah L. Boaz, North Hollywood, CA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/017,951

(22) Filed: Dec. 13, 2001

(51) Int. Cl. G06F 15/16; G06F 15/163

(52) U.S. Cl. 709/203; 709/311

(57) ABSTRACT

A system and method for optimizing network routing using the network topology is described. The method includes a user sending a request for information to a server. The server receives this request and send to the user the requested information in addition to a client side program. The client program then reads and saves the local user time. The user then sends another request for information to the server. In this request is embedded the local user time saved by the client side program. A server side program residing on server then receives the request and the local user time. The server side program uses the local server time to determine the topological location of the user and the identity of the server that is best suited to handle the request by the user. Finally, the server forwards the request of the user to the identified server.

### CROSS-REFERENCE TO RELATED APPLICATIONS

Not applicable.

### BACKGROUND OF THE INVENTION

1. Field of the Invention

The present invention relates to the field of network routing. More specifically, the present invention relates to the field of optimizing network routing based on the network topology.

2. Description of Related Art

The growth of the Internet has known no boundaries. The Internet has affected business and commerce across national, geographical and cultural borders. Business firms and individuals across the globe use the Internet to sell products and services domestically and internationally. Governments and administrative agencies of countless countries use the Internet to provide information and services to interested parties anywhere on the earth. Schools and researchers use the Internet to conduct global research and instruct students. Overall, the Internet houses incalculable amounts of information available from all over the world.

As a result of the distribution of information around the world, a network topology defining the Internet has arisen. This topology defines connections and relationships between different nodes on the network. This topology also defines the rate at which information can be uploaded and downloaded from one node to another. Several factors affect the strength of a connection between two nodes. One factor is the length of the shortest path that exists between two nodes. Another factor is the bandwidth of the connections between two nodes. These factors affect the way in which two nodes can interact with each other. Namely, these factors affect the rate at which information can be accessed from one node to another.

Often, information nodes or sites have “mirrors” or duplicates in different locations around the world. This mirroring attempts to facilitate access to the information for a variety of users around the globe. Optimizing the routing of an information request to a particular information site, however, can be a difficult task given the complexity of the Internet's topology. Typically, when a user attempts to access a site that has mirrors, the user is prompted to choose the location of the mirror site that is nearest to him. This procedure is performed in order to find a server that is topologically closest to the user—hence resulting in a faster connection between the user and the information site. This technique, however, can be annoying as it interrupts any task in which the user may be involved. Also, it is not guaranteed that the user will choose the server that is topologically closest to the user.

Accordingly, what is needed is a method for seamlessly optimizing network routing.

### SUMMARY OF THE INVENTION

Briefly, in accordance with the present invention, disclosed is a system and method for optimizing network routing using the network topology. In an embodiment of the present invention, the method includes a user sending a request (i.e, a HyperText Transfer Protocol request), for information such as web content to a server (i.e., an e-business server). The server receives this request and sends to the user the requested information in addition to a client side program such as a Java scriptlet. The client program then reads and saves the local user time. The user then sends another request for information to the server. In this request is embedded the local user time saved by the client side program. A server side program, such as a Java servlet, residing on server then receives the request and the local user time. The server side program uses the local server time to determine the topological location of the user on the network. The server side program then uses the topological location of the user to determine the identity of the server that is best suited to handle the request by the user. Finally, the server forwards the request of the user to the server that is best suited to fulfill the request of the user.

In another embodiment of the present invention, the server side program determines the topological location of the user on the network by considering the local time of the user, the geographical location of the user and the topology of the network of the user.

In another embodiment of the present invention, the server side program determines the identity of the server that is best suited to fulfill the request of the user by considering the topological location of the user, the topological location of the other servers on the network, the capability of the other servers on the network to fulfill the user's request, the strength of the connection between the user and the other servers and the processing load of the other servers on the network.

One advantage of the present invention is the optimization of the routing between two nodes on the network. This can lead to quicker access times and data transfer rates between two nodes.

Another advantage of the present invention is reduction of network traffic in high-density areas of the network. As the present invention directs network traffic to nodes that are better equipped to handle requests, bottlenecks and problem areas of the network can be avoided. This can also lead to quicker access times and data transfer rates.

The foregoing and other features and advantages of the present invention will be apparent from the following more particular description of the preferred embodiments of the invention, as illustrated in the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram illustrating the overall system architecture of an embodiment of the present invention, showing connectivity among the various components.

FIG. 2 is an illustration of a network topology, in an embodiment of the present invention, showing connectivity among the various components.

FIG. 3 is an illustration showing client side programs and server side programs, in an embodiment of the present invention, showing connectivity among the various components.

FIG. 4 is a flowchart depicting an embodiment of the operation and control flow of the overall process of the present invention.

FIG. 5 is a flowchart depicting an embodiment of the operation and control flow of the topological location determination process of the present invention.

FIG. 6 is a flowchart depicting an embodiment of the operation and control flow of the best-server determination process of the present invention.

FIG. 7 is a block diagram of an exemplary computer system useful for implementing the present invention.

### DETAILED DESCRIPTION OF THE PREFERRED EMBODIMENT

To more clearly delineate the present invention, an effort is made throughout the specification to adhere to the following term definitions as consistently as possible.

The term “web page” or “web content” is used to refer to a file or portion of a file, typically written in Hypertext Markup Language (HTML), Java®, Extended Markup Language (XML), Active Server® or Cold Fusion® format. Such a file is typically viewed using a web browser.

The term “web site” is used to refer to a group of web pages that are associated in some manner, such as geographically, contextually or categorically. A web site usually refers to a group of web pages located within one domain name.

The term “link” is used to refer to any item on a web page or e-mail that, when clicked (i.e., activated), opens a connection (i.e., “jumps”) to another web site or web page. Textual links are typically referred to as “Hyper Text.”

The term “Uniform Resource Locator (URL)” is used to refer to an Internet address for a web page or web site. A link to a web site usually contains a URL. The terms “URL” and “link” can be used interchangeably.

The term “request” is used to refer to a request by a computer for a file, web page, web content, or email over the Internet. Examples of a request include a HyperText Transfer Protocol (HTTP) request for a web page, a File Transfer Protocol (FTP) request for a file, and a Simple Mail Transfer Protocol (SMTP) request for an email.

The term “browser” is used to refer to a computer program, such as a web browser, that can be used to view a web page.

The term “user” is used to refer to a person using a browser, executing on a computer system, to view a web page.

The term “server side program” is used to refer to a program that is located on the server side of a client server system. Examples of widely used server side programs are: Common Gateway Interface (CGI) scripts, Java servlets, Hypertext Preprocessor (PHP) scripts and Perl scripts.

The term “client side program” is used to refer to a program that is located and runs on the client's side of a client server system. Examples of widely used client side programs are: Java applets, Java scriplets, Java scripts and Active X controls.

The present invention is described in terms of the examples below. This is for convenience only and is not intended to limit the application of the present invention. In fact, after reading the following description, it will be apparent to one skilled in the relevant art(s) how to implement the following invention in alternative embodiments.

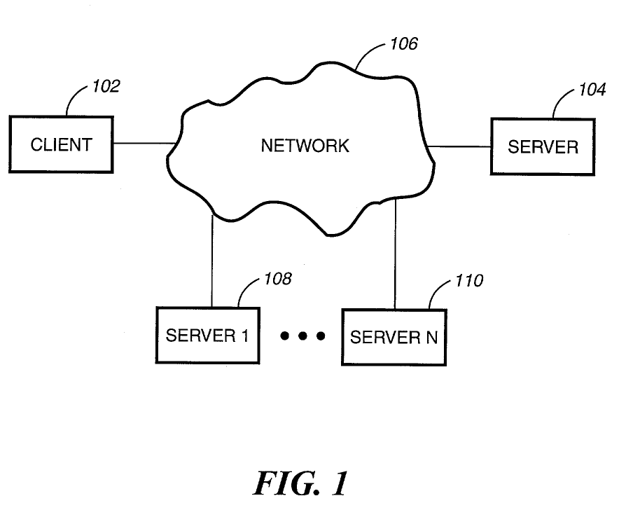

FIG. 1 is a block diagram illustrating the overall system architecture of an embodiment of the present invention, showing connectivity among the various components. FIG. 1 is a generalized embodiment of the present invention. System 100 includes a client 102, a server 104, and a packet switched network 106. System 100 also includes a plurality of servers, ranging from a first server 108 to an Nth server 110. In one embodiment, network 106 is a packet switched wide area network (WAN) such as the global internet. Network 106 can alternatively be a private WAN, a local area network (LAN), a telecommunications network or any combination of the above-mentioned networks.

Client 102 can be an individual or a business entity with access to a network-capable device. Such a device includes a PC (e.g., an IBM or compatible PC workstation running the Microsoft Windows 95/98 or Windows NT operating system, Macintosh computer running the Mac OS operating system, or the like), a personal digital assistant (PDA), a game console or any other network-capable processing device used to communicate with server 104. Client 102 can also be referred to as a “user.”

Server 104 serves as the “back-bone” (i.e., the processing) of the present invention. In an embodiment of the present invention, server 104 is one or more SUN Ultra workstations running the SunOS operating system. In another embodiment, server 104 is one or more IBM or compatible personal computer (PC) workstations with an Intel Pentium III processor running either the Windows NT operating system or the BSD Unix operating system. Server 104 is connected to network 106 that serves as the communications medium between server 104 and its clients (e.g., client 102). While only one client 102 and a group of servers are shown in FIG. 1 for ease of explanation, it will be apparent to one skilled in the relevant art(s) that system 100 may support any number of clients 102 and servers.

Administrative personnel may enter information into server 104. Personnel may enter into server 104 information that may be used in determining the best-suited server to respond to a user's request. This is explained in greater detail below. Also, client and user information (e.g., logins, passwords, etc.) for each of the clients and users that utilize server 104 can be uploaded, updated, and maintained within server 104. Server 104 may monitor and log statistics related to server 104 and system 100 in general. In addition, server 104 may be used “off-line” by administrative personnel of system 100 in order to enter configuration data.

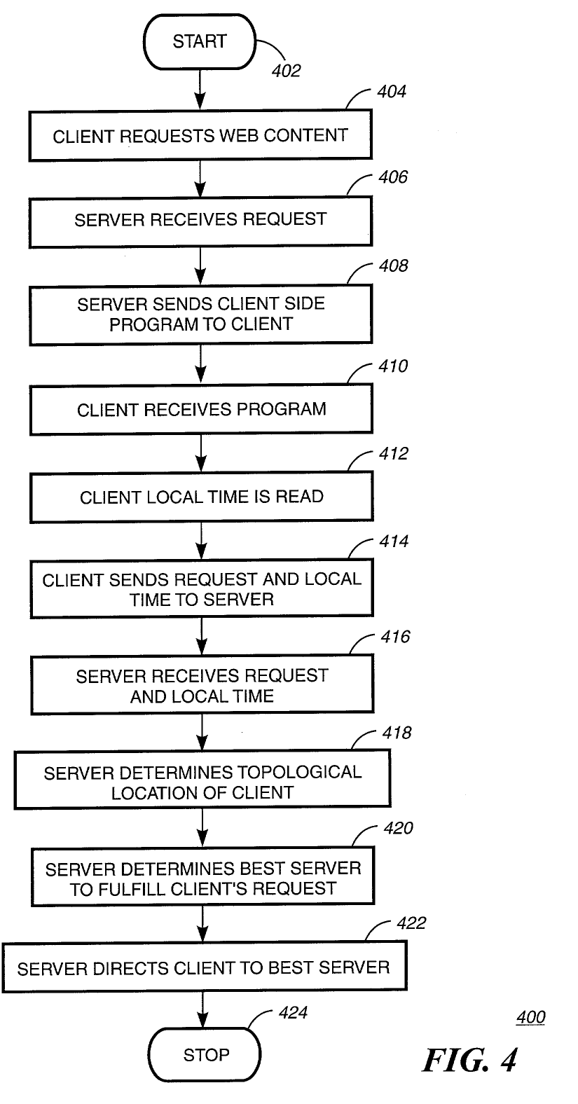

More detailed descriptions of system 100 components, as well as their functionality and inter-functionality with other system 100 components, are provided below. The operation of FIG. 1 is shown in the flow chart of FIG. 4.

A network consists of many nodes and the relationships or connections between those nodes. Nodes can be computers such as web servers, database servers and individual PCs connecting to the network. The connections between the nodes can be Internet connections, telephone connections, Ethernet connections, wireless connections, and the like. The network as a whole can be a packet switched network such as the Internet or a circuit switched network such as the Public Service Telephone Network (PSTN), also known as the Plain Old Telephone System (POTS).

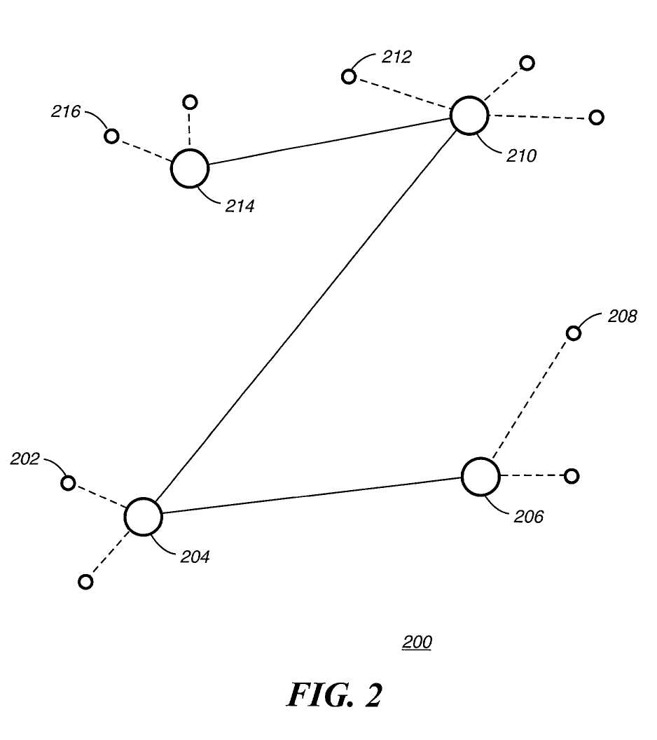

Network topology is the study of the physical lay out of a network. A network topology map shows the relationships or connections between nodes. FIG. 2 is an illustration of an exemplary network topology 200, in an embodiment of the present invention, showing connectivity among the various components. Topology 200 represents a portion of the Internet, showing a variety of nodes and connections. The smaller nodes, such as nodes 202, 208, 212 and 216, represent individual computers such as typical home PCs. The smaller nodes 202, 208, 212 and 216 correspond to client 102 of FIG. 1. The larger nodes, such as nodes 204, 206, 210 and 214, represent larger providers of information such as web servers and database servers. The larger nodes 204, 206, 210 and 214 correspond to the group of servers 108 to 110 of FIG. 1.

The solid lines in topology 200 represent connections with high bandwidth. Such connections include T1, T3, Digital Subscriber Line (DSL) and other broadband connections. Most commonly, as shown in topology 200, these connections are employed by the larger nodes to connect to each other. The dotted lines in topology 200 represent connections of lower bandwidth. Such a connection includes a telephone connection. Most commonly, as shown in topology 200, these connections are employed by the individual computers to connect to a larger node.

A quality of communication within a network can be affected by many factors. One factor is topological distance. The topological distance between two nodes can affect the quality of communication between the two nodes because of the time required to transmit and receive data over distances. Thus, communication between node 208 and node 204 can be of better quality than communication between node 208 and node 210 because of the larger topological distance between node 208 and node 210. The strength of a connection can also affect the quality of communication between two nodes. A high bandwidth connection can provide better communication than a low bandwidth connection because of the increased ability of a high bandwidth connection to transmit and access information. Thus, the communication between node 204 and node 206 can be of better quality than the communication between node 206 and node 208 because of the high bandwidth connection between node 204 and node 206.

Processing capacity can also affect the quality of communication between two nodes. The processing capacity of a computer affects the amount of requests or tasks that the computer can handle at one time. The processing capacity of a computer can also affect the time required to complete a request or task. Thus, for example, if node 210 has the option of sending a request or task to either node 214 or node 204, node 210 should send the request or task to the node with the greatest processing capacity (with all other variables held to be the same).

Furthermore, processing load can also affect the quality of communication between two nodes. The processing load of a web server or a database system can affect the ability of the computer to handle additional requests. That is, as the processing burden on a web server or database system increases, the ability of the web server or database system to handle additional requests decreases. Thus, for example, if node 210 has the option of sending a request to either node 214 or node 204, node 210 should send the request to the node with the smallest processing burden (with all other variables held to be the same).

The present invention involves the use of client side programs and server side programs. As described above, a client side program is a program that executes on the client side of a client-server paradigm. A common client side program is a Java scriptlet. Java scriptlets are normally transmitted to a client from a server using the Internet Protocol (IP) while the user is browsing the web. Also described above, a server side program is a program that executes on the server side of a client-server paradigm. A common server side program is a Java servlet. Java servlets are normally used by a server to handle interactions with a client.

The system of the present invention comprises the use of a client side program that can read and store the local user time. The client side program of the present invention is embedded in the source code for a link. Specifically, the client side program reads the local user time and embeds this information as the value of a variable within the link. When this link is followed, the local user time is sent to a server side program at the server.

In one example, the client side program is Java script that is embedded in an HTML file that is sent to client 102 in response to a request by client 102. Below is an example of an HTML file with the described Java script:

<HTML>

<HEAD>

<SCRIPT LANGUAGE=“JavaScript”>

function writeLocalizedLink (link, description) {

document.write(′<a href=“ ′ + link + “?clientTimezoneOffset=” +
(new Date()) .getTimezoneOffset() + ′“>′ + description + “</a>”);

}

</SCRIPT>
<BODY>

. . .
<SCRIPT LANGUAGE= “JavaScript”>
WriteLocalizedLink (

“http://127.0.0.1:8080/servlet/TimezoneServlet”,
“Localized Link To Servlet”)

</SCRIPT>
. . .
<BR>

</BODY>

</HEAD>

Shown above is an HTML file that is received by client 102 and displayed in his web browser. The Java script function “writeLocalizedLink” above is responsible for writing the link into which the local user time is embedded. It can be seen that “writeLocalizedLink” is defined in the top portion of the file and then called in the lower portion of the file.

As the web browser processes the above HTML file for display, the Java script function “writeLocalizedLink” is executed. Upon execution, the Java script function “writeLocalizedLink” begins to write a standard “Href” link to the browser. While writing this link, the function “getTimezoneOffset” is called—this standard function is supported by the Microsoft Windows 98/2000 and Windows NT operating system. The “getTimezoneOffset” function reads from the computer of client 102 the difference, in minutes, between the local user time and standard Greenwich Mean Time (GMT). This difference is then written as the value of the “clientTimezoneOffset” variable. The result of the “writeLocalizedLink” function is a link that contains the time zone read from the computer of client 102. Shown below is an example of the HTML code representing the link described above:

<a Href=“http://127.0.0.1:8080/servlet/TimezoneServlet? clientTimezoneOffset=−120” >Localized Link To Servlet< /a>

The link above shows that the time zone difference between the local computer and GMT is negative 120 minutes or two hours behind. The link also shows that the “TimezoneServlet” Java servlet is called when the link is activated. That is, when the user clicks the link, an HTTP request is sent to the server. This HTTP request specifies that the “TimezoneServlet” Java servlet will handle the HTTP request insofar as handling the value of the “clientTimezoneOffset” variable.

The system of the present invention comprises the use of a server side program that can determine the server that is best suited to handle the request of the client. In this example, the TimezoneServlet Java servlet, a server side program, receives the HTTP request sent by the client side program. As discussed above, the HTTP request was initiated by client 102 upon clicking a link. As a result, an HTTP request for web content defined by the link is generated by the web client of client 102. The following portion of the link defines the web content requested: http://127.0.0.1:8080. In addition, the HTTP request also includes the clientTimezoneOffset variable and its corresponding value. The TimezoneServlet Java servlet receives this information and commences processing.

The server side program of the present invention uses the received information to determine the server that is best suited to fulfill the request of client 102. In one embodiment of the present invention, the server side program performs this determination by taking into consideration the factors that affect the quality of communication in a network. Specifically, the server side program takes into account the factors that affect the quality of communication between the requesting client 102 and the servers that are able to fulfill the request of client 102. As discussed above, the factors that affect the quality of communication between two nodes includes, but is not limited to, the topological distance between nodes, the strength of the connection between the nodes, and the processing capacity of the server node and the processing load of the server node. Each of the above factors is described in greater detail below. Other factors that may affect the quality of communication between two nodes may be included, as deemed by one of ordinary skill in the art.

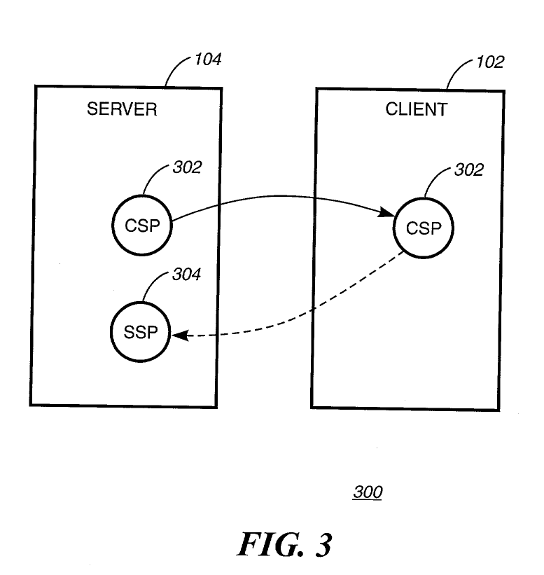

FIG. 3 is an illustration showing the interaction between client side programs and server side programs, in an embodiment of the present invention, showing connectivity among the various components. FIG. 3 shows system 300 whereby server 104 and client 102 interact. As described above, client side program 302 originally resides at server 104. In response to a request by client 102, server 104 sends client side program 302 to client 102. Client side program 302 then reads the time zone information of client 102. In response to client 102 activating client side program 302, by, for example, clicking on a link, client side program 302 sends a request to server 104. The request includes the time zone information of client 102. The request is then handled by a server side program 304. Server side program 304 uses the time zone information of client 102 to determine the server that is best suited to handle the request of client 102.

In an embodiment of the present invention, client side program 302 reads a Global Positioning System (GPS) coordinate from client 102. A GPS coordinate defines a location on the earth, typically within an accuracy of about 600 feet to about 15 feet. Thus, a GPS coordinate is a more accurate estimation of a user's geographical information than time zone information. As explained above, the GPS information is then sent to server 104 and handled by server side program 304. Server side program 304 then uses the GPS information of client 102 to determine the server that is best suited to handle the request of client 102.

As discussed above, the topological distance between nodes can affect the time required to transmit and receive information between nodes. The estimation of the topological distance between client 102 and another node begins with the estimation of the geographical location of client 102. As described above, server 104 receives the local time zone of client 102 offset from GMT via the client side program. Using the local time zone of client 102 offset from GMT, server 104 can estimate the geographical location (namely, the country) of client 102. In an embodiment of the present invention, server 104 can estimate the geographical location of client 102 using GPS information from client 102.

Few time zones belong to more than one significant continent or country. One big exception is Africa and Europe, who share several time zones. However, Africa is not a major participant of the global Internet. Therefore, using probability, any client belonging to a time zone attributed to both continents will be deemed to belong to Europe. Another exception is North America and South America, who share the Eastern time zone for half of the year. For the same reasons as those for Europe and Africa, any client belonging to a time zone attributed to both continents will be deemed to belong to North America.

The next step in the estimation of the topological distance between client 102 and another node is to estimate the topological location of client 102. This value can be estimated from the geographical location of client 102 because the current topology of the global Internet mirrors global geography. That is, the current topology of the Internet emulates the contours of the globe and the densities of populations on the Earth. Therefore, once geographical location is established, topological location can be estimated using this information.

The topological distance between two nodes can be calculated in a variety of ways. In one embodiment of the present invention, the topological distance between a first node and a second node reflects the number of intervening nodes between the first and second node. Thus, the topological distance between node 208 and node 210 (see FIG. 2) reflects two intervening nodes whereas the topological distance between node 208 and node 204 reflects only one intervening nodes. Therefore, topologically, node 208 is closer to node 204 than to node 210. In contrast, using geographic distances, node 208 is closer to node 210 than to node 204.

In another embodiment, the topological distance between two nodes reflects other factors in addition to the number of intervening nodes. As discussed above, the strength of the connection (or the bandwidth of the connection) between nodes can affect the rate at which information can be transmitted and received between nodes. Server 102 can determine the bandwidth of the connection between two nodes using a variety of techniques. One technique for making this determination is to send a request to all or some of the nodes that constitute the connection between the two nodes. The request would ask for a response describing the bandwidth of the connection between each node segment. Once the bandwidth for each node segment is determined, the bandwidth for the entire connection between two nodes can be calculated using a sum or averaging technique. This technique, however, is time-consuming and does not guarantee an accurate assessment of bandwidth.

Another technique for determining the bandwidth of the connection between two nodes involves pinging. A ping is a message sent from one node to another with a request for an immediate response. The time required to receive a response from another node reflects the bandwidth of the connection between two nodes.

The processing capacity of a server node can affect the time required by the server node to fulfill a request of the client node. In addition, the processing load of the server node can also affect the time required by the server node to fulfill a request of the client node as well as the rate at which the server node can transmit and receive information from the client node. Server 102 can determine the processing load and capacity of other servers by sending a request to those servers. The request would seek a response describing the processing load and capacity of each server. In one embodiment of the present invention, server 102 can send a Simple Network Management Protocol (SNMP) request to each server. This request can seek utilization information for each server. This information can be used to calculate the capacity of each server to serve additional requests.

In an embodiment of the present invention, the server side program can determine the best-suited server to fulfill the request of client 102 by taking into consideration the above factors in a variety of formulas. One formula that may be used is a scoring formula. This formula starts by finding all of the servers that can fulfill the request of client 102. For example, all servers that possess the web page that is being requested by the HTTP request of client 102 are found. Each of the servers in the group is then scored in relation to each factor that may affect the quality of communication between the server and client 102. Thus, taking the embodiment above, each server is scored in 1) topological distance from client 102, 2) strength of connection, 3) processing capacity and 4) processing load. Then, each server is given a total score consisting of the sum of the individual scores for each factor. The server with the highest total score is determined to be the server best suited to fulfill the request of client 102.

In another embodiment of the present invention, the formula above can be modified to include only one factor, or any combination of factors described above. In another embodiment, the formula above can be modified by adding weights to the scores given to the individual factors. Thus, under this example, some factors scores can be given more weight than other factor scores. In yet another embodiment of the present invention, the formula above can be modified or alternate formulas can be used, as deemed appropriate by one of ordinary skill in the art.

FIG. 4 is a flow chart depicting an embodiment of the overall operation and control flow 400 of the present invention. The overall operation of FIG. 1 and FIG. 2 is shown in flow 400. Control flow 400 begins with step 402 and flows directly to step 404.

In step 404, client 102 sends a request to server 104. In this example, client 102 sends an HTTP request for a web page.

In step 406, server 104 receives the request of client 192.

In step 408, server 104 sends to client 102 the requested information in addition a client side program. In this example, server 104 sends to client 102 the requested web page in which is embedded Java script for reading and sending the local time zone information.

In step 410, client 102 receives the requested information as well as the client side program.

In step 412, the client side program reads local time zone information. In this example, the received Java script reads from the computer of client 102 the local time zone of the computer offset from GMT. This value is embedded as the value of a variable in a link displayed in the web browser of client 102. In an embodiment of the present invention, the received Java script reads from the computer of client 102 the GPS coordinate of client 102.

In step 414, client 102 sends to server 104 a request and local time zone information. In this example, client 102 clicks on the link described above. In response, client 102 sends an HTTP request to server 104. The HTTP request is a request for a web page. Embedded in the HTTP request is the local time zone of the computer offset from GMT.

In step 416, server 104 receives the request of client 102 as well as the local time zone information.

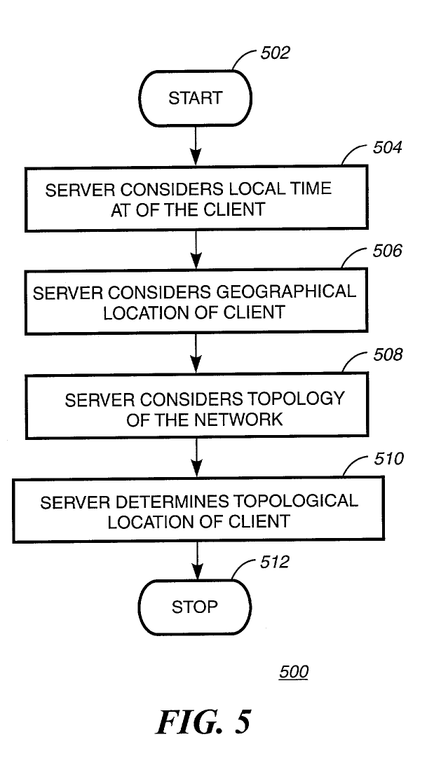

In step 418, server 104 estimates the topological location of the user. In this example, this step is accomplished by a server side program. This step is described in greater detail below and in the flowchart of FIG. 5.

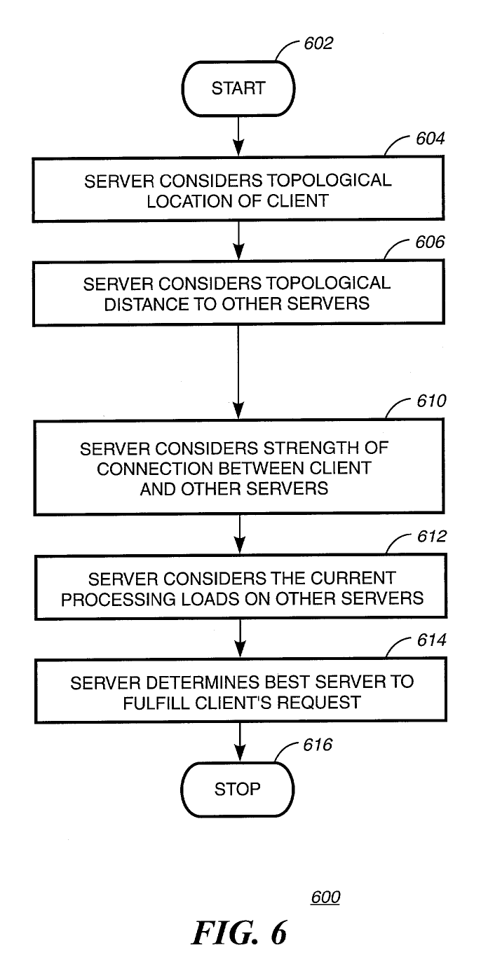

In step 420, server 104 determines the server best suited to fulfill the request of client 102. In this example, this step is accomplished by a server side program. This step is described in greater detail below and in the flowchart of FIG. 6.

In step 422, server 104 directs client 102 to the server it determines to be best suited to handle the request of client 102. In this example, server 104 accomplishes this task using standard URL redirection. Redirection is an HTTP process by which a user or client is told to obtain a certain web page at another location.

In step 424, flow 400 ceases.

FIG. 5 is a flowchart depicting an embodiment of the operation and control flow 500 of the topological location determination process of the present invention. Step 418 (see FIG. 4) is described in greater detail in flow 500. Control flow 500 begins with step 502 and flows directly to step 504.

In step 504, server 104 calculates the local time of client 102 using the local time zone information that is sent to server 104 in step 416. This information is one factor used in the determination of the topological location of client 102.

In step 506, server 104 estimates the geographical location of client 102 based on the local time zone information of client 102. This information is another factor used in the estimation of the topological location of client 102.

In step 508, server 104 considers the topology of the network in which client 102 is located. This information is another factor used in the estimation of the topological location of client 102.

In step 510, server 104 estimates the topological location of client 102 based on the factors considered above.

In step 512, flow 500 ceases.

In an embodiment of the present invention, each step in control flow 500 is accomplished by a server side program at server 104. Each step of control flow 500 is described in greater detail above.

FIG. 6 is a flowchart depicting an embodiment of the operation and control flow 600 of the best-server determination process of the present invention. Step 402 (see FIG. 4) is described in greater detail in flow 600. Control flow 600 begins with step 602 and flows directly to step 604.

In step 604, server 104 considers the topological location of client 102. The topological location of client 102 is estimated in control flow 500 (see FIG. 5). This information is one factor used in the best-server determination.

In step 606, server 104 considers the topological distance between client 102 and the other servers on the network that can fulfill the request of client 102. This information is another factor used in the best-server determination.

In step 610, server 104 considers the strength of the connection between client 102 and the other servers on the network that can fulfill the request of client 102. This information is another factor used in the best-server determination.

In step 612, server 104 considers the processing capacities and the current processing loads of the other servers on the network that can fulfill the request of client 102. This information is another factor used in the best-server determination.

In step 614, server 104 determines the server that is best suited to handle the request of client 102 based on the factors considered above.

In step 616, flow 600 ceases.

In an embodiment of the present invention, each step in control flow 600 is accomplished by a server side program at server 104. Each step of control flow 600 is described in greater detail above.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

A preferred embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

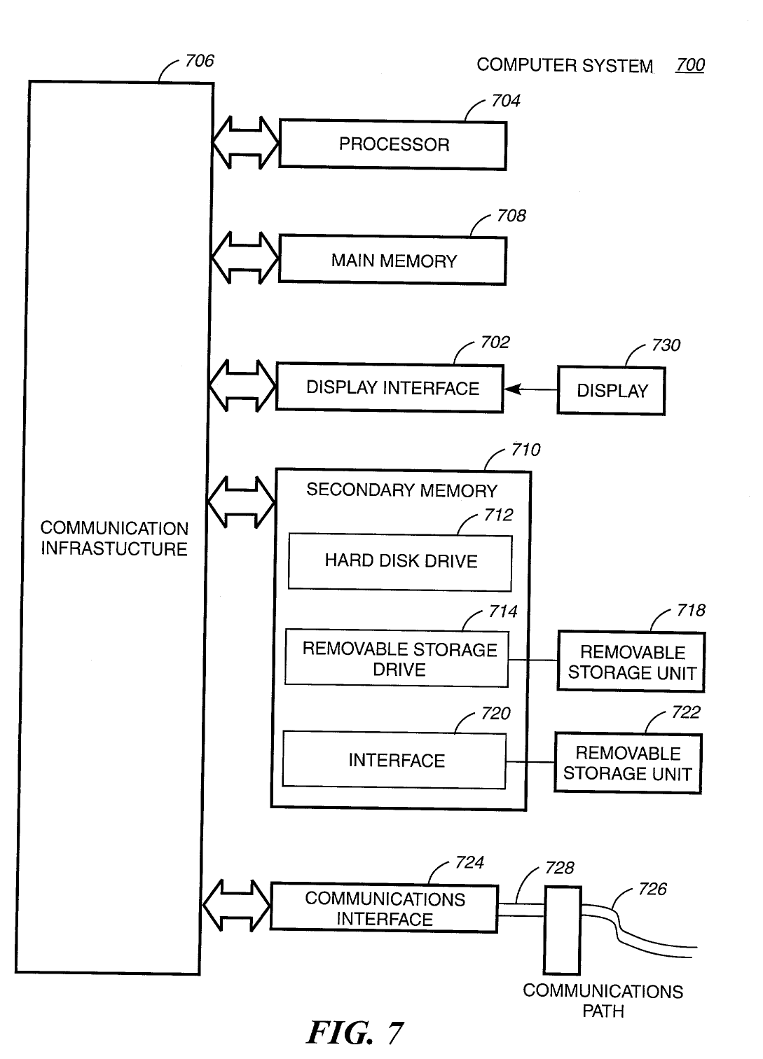

An example of a computer system 700 is shown in FIG. 7. The computer system 700 includes one or more processors, such as processor 704. The processor 704 is connected to a communication infrastructure 706 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 700 can include a display interface 702 that forwards graphics, text, and other data from the communication infrastructure 706 (or from a frame buffer not shown) for display on the display unit 730.

Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a PCMCIA slot and card, etc. Software and data transferred via communications interface 724 are in the form of signals 728 which may be electronic, electromagnetic, optical or other signals capable of being received by communications interface 724. These signals 728 are provided to communications interface 724 via a communications path (i.e., channel) 726. This channel 726 carries signals 728 and may be implemented using wire or cable, fiber optics, a phone line, a cellular phone link, an RF link and other communications channels.

In this document, the terms “computer program medium,” “computer usable medium,” and “computer readable medium” are used to generally refer to media such as removable storage drive 714, a hard disk installed in hard disk drive 712, and signals 728. These computer program products are means for providing software to computer system 700. The computer readable medium allows the computer system 700 to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems 700. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform the features of the computer system 700. Accordingly, such computer programs represent controllers of the computer system 700.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for directing a user on a network to a server, comprising the steps of:
sending to the user a client side program that reads the local time of the user;
receiving from the user a request and the local time of the user, wherein the client side program effectuated the sending of the local time of the user;
determining from the local time of the user the topological location of the user on the network;
determining from the topological location of the user the identity of the server that is capable of fulfilling the user's request and that is topologically nearest to the user; and
directing the user to the identified server,
wherein the time required to satisfy the request of the user is optimized.

2. The method of claim 1, wherein the request of the user comprises any one of:
a Hyper Text Transfer Protocol request;
a File Transfer Protocol request; and
a Simple Mail Transfer Protocol request.

3. The method of claim 2, wherein the client side program comprises any one of:
a Java applet;
a Java scriptlet;
a Java script; and
an Active X control.

4. The method of claim 2, wherein the receiving step comprises the step of:
receiving from the user a request and the local time of the user in response to the activation of the client side program by the user.

5. The method of claim 4, wherein the activation of the client side program by the user comprises the user clicking on a link.

6. The method of claim 2, wherein the first determining step comprises the step of:
determining the topological location of the user on the network, wherein the determining takes the following factors into account:
the local time of the user;
the geographical location of the user; and
the topology of the network of the user.

7. The method of claim 6, wherein the first determining step further comprises the step of:
employing a server side program for the determining step, wherein the server side program comprises any one of:
a Common Gateway Interface script;
a Java servlet;
a Hyper Text Preprocessor script; and
a Perl script.

8. The method of claim 2, wherein the second determining step comprises the step of:
determining the identity of the server that is capable of fulfilling the user's request and that is topologically nearest to the user, wherein the determining takes the following factors into account:
the topological location of the user on the network;
the topological location of other servers on the network;
the capability of other servers on the network to fulfill the user's request;
the strength of the connection between the user and other servers on the network; and
the processing load of the other servers on the network.

9. The method of claim 8, wherein the second determining step further comprises:
employing a server side program for the determining step, wherein the server side program comprises any one of:
a Common Gateway Interface script;
a Java servlet;
a Hyper Text Preprocessor script; and
a Perl script.

10. The method of claim 2, wherein the directing step comprises the step of:
forwarding the request of the user to the identified server.

11. A method for directing a user on a network to a server, comprising the steps of:
receiving from the user a Hyper Text Transfer Protocol (HTTP) request for web content;
sending to the user, in response to the HTTP request, web content comprising a client side program, wherein the client program reads the local time of the user and embeds the local time of the user into a link;
receiving from the user, in response to the user clicking on the link, an HTTP request for a web page, wherein the HTTP request includes the local time of the user;
determining from the local time of the user, using a server side program, the topological location of the user on the network;
determining from the topological location of the user, using a server side program, the identity of the server that is capable of fulfilling the user's request and that is topologically nearest to the user; and
forwarding the request of the user to the identified server, wherein the time required to satisfy the request of the user is optimized.

12. The method of claim 11, wherein the client side program comprises any one of:
a Java applet;
a Java scriptlet;
a Java script; and
an Active X control.

13. The method of claim 11, wherein the first determining step comprises the step of:
determining, using a server side program, the topological location of the user on the network, wherein the determining takes the following factors into account:
the local time of the user;
the geographical location of the user; and
the topology of the network of the user.

14. The method of claim 13, wherein the first determining step further comprises the step of:
employing a server side program for the determining step, wherein the server side program comprises any one of:
a Common Gateway Interface script;
a Java servlet;
a Hyper Text Preprocessor script; and
a Perl script.

15. The method of claim 11, wherein the second determining step comprises the step of:
determining, using a server side program, the identity of the server that is capable of fulfilling the user's request and that is topologically nearest to the user, wherein the determining takes the following factors into account:
the topological location of the user on the network;
the topological location of other servers on the network;
the capability of other servers on the network to fulfill the user's request;
the strength of the connection between the user and other servers on the network; and
the processing load of the other servers on the network.

16. The method of claim 15, wherein the second determining step further comprises:
employing a server side program for the determining step, wherein the server side program comprises any one of:
a Common Gateway Interface script;
a Java servlet;
a Hyper Text Preprocessor script; and
a Perl script.

17. A computer system for directing a user on a network to a server, comprising:
a client side program that reads the local time of the client and embeds the local time of the user in a link;
a web server for sending web content to a user in response to a request of the user, wherein the web content sent to the user comprises the client side program;
a server side program for receiving a request from the user, wherein the request is initiated by activation of the client side program and wherein the request includes the local time of the user, wherein the server side program determines from the local time of the user the identity of the server that is best capable of fulfilling the user's request.

18. The computer system of claim 17, wherein the client side program comprises any one of:
a Java applet;
a Java scriptlet;
a Java script; and
an Active X control.

19. The computer system of claim 17, wherein the server side program comprises any one of:
a Common Gateway Interface script;
a Java servlet;
a Hyper Text Preprocessor script; and
a Perl script.

20. The computer system of claim 17, wherein the request of the user comprises any one of:
a Hyper Text Transfer Protocol request;
a File Transfer Protocol request; and
a Simple Mail Transfer Protocol request.

21. A computer readable medium including computer instructions for directing a user on a network to a server, the computer instructions comprising instructions for:
sending to the user a client side program that reads the local time of the user;
receiving from the user a request and the local time of the user, wherein the client side program effectuated the sending of the local time of the user;
determining from the local time of the user the topological location of the user on the network;
determining from the topological location of the user the identity of the server that is capable of fulfilling the user's request and that is topologically nearest to the user; and
directing the user to the identified server, wherein the time required to satisfy the request of the user is optimized.

22. The computer readable medium of claim 21, wherein the request of the user comprises any one of:
a Hyper Text Transfer Protocol request;
a File Transfer Protocol request; and
a Simple Mail Transfer Protocol request.

23. The computer readable medium of claim 22, wherein the client side program comprises any one of:
a Java applet;
a Java scriptlet;
a Java script; and
an Active X control.

24. The computer readable medium of claim 22, wherein the first determining means comprises:
determining the topological location of the user on the network, wherein the determining takes the following factors into account:
the local time of the user;
the geographical location of the user; and
the topology of the network of the user.

25. The computer readable medium of claim 22, wherein the second determining means comprises:
determining the identity of the server that is capable of fulfilling the user's request and that is topologically nearest to the user, wherein the determining takes the following factors into account:
the topological location of the user on the network;
the topological location of other servers on the network, the capability of other servers on the network to fulfill the user's request;
the strength of the connection between the user and other servers on the network; and
the processing load of the other servers on the network.
